(19) United States
(12) Patent Application Publication
(10) Pub. No.: US 2024/0288642 A1
(43) Pub. Date: Aug. 29, 2024

(54) OPTICAL MODULE

(71) Applicant: InnoLight Technology (Suzhou) Ltd., Suzhou (CN)

(72) Inventors: LONG CHEN, Suzhou (CN); Xiong-Fei Zhai, Suzhou (CN); YU-ZHOU SUN, Suzhou (CN); Dong-Han WANG, Suzhou (CN); Deng-Qun YU, Suzhou (CN); An-Li Li, Suzhou (CN); Chun-Feng Qian, Suzhou (CN)

(21) Appl. No.: 18/652,952

(22) Filed: May 2, 2024

Related U.S. Application Data
(63) Continuation-in-part of application No. PCT/CN2021/135613, filed on Dec. 6, 2021.
(63) Continuation-in-part of application No. PCT/CN2022/112093, filed on Aug. 12, 2022.
(63) Continuation-in-part of application No. PCT/CN2022/112095, filed on Aug. 12, 2022.
(63) Continuation-in-part of application No. PCT/CN2022/112096, filed on Aug. 12, 2022.

(30) Foreign Application Priority Data
Nov. 5, 2021 (CN) 202111305635.9
Nov. 5, 2021 (CN) 202111307026.7
Nov. 5, 2021 (CN) 202122696566.0
Nov. 5, 2021 (CN) 202122698491.X

(51) Int. Cl. G02B 6/42; G02B 6/43

(52) U.S. Cl. CPC G02B 6/426; G02B 6/4204; G02B 6/428; G02B 6/43; G02B 6/4269

(57) ABSTRACT

An optical module includes a housing, a circuit board assembly, an optical assembly, and an optical receptacle. The housing includes first and second housings and an optical fiber adapter. The circuit board assembly includes a rigid circuit board. The optical assembly is fixed on the first housing and includes an optical processing assembly and photoelectric chips. The optical processing assembly includes a wavelength division multiplexer, a lens group located between the wavelength division multiplexer and the photoelectric ship, and a lens group located between the wavelength division multiplexer and the optical receptacle. The photoelectric chips are close to the rigid circuit board and are electrically connected to the rigid circuit board. The optical fiber adapter is arranged at an optical interface of the housing and is integrally formed with the optical interface.

### CROSS-REFERENCE TO RELATED PATENT APPLICATION

This application is a continuation-in-part application of International Patent Application Ser. No. PCT/CN2022/112095, filed on Aug. 12, 2022, the international application of which was published on May 11, 2023, as International Publication No. WO2023077903A1, and claims the priority of China Patent Application No. CN202122696566.0, filed on Nov. 5, 2021 in People's Republic of China. The entirety of each of the above patent applications is hereby incorporated by reference and made a part of this specification.

This application is a continuation-in-part application of International Patent Application Ser. No. PCT/CN2022/112093, filed on Aug. 12, 2022, the international application of which was published on May 11, 2023, as International Publication No. WO2023077902A1, and claims the priority of China Patent Application No. CN202122698491.X, filed on Nov. 5, 2021 in People's Republic of China. The entirety of each of the above patent applications is hereby incorporated by reference and made a part of this specification.

This application is a continuation-in-part application of International Patent Application Ser. No. PCT/CN2021/135613, filed on Dec. 6, 2021, the international application of which was published on May 11, 2023, as International Publication No. WO2023077600A1, and claims the priority of China Patent Application No. CN202111305635.9, filed on Nov. 5, 2021 in People's Republic of China. The entirety of each of the above patent applications is hereby incorporated by reference and made a part of this specification.

This application is a continuation-in-part application of International Patent Application Ser. No. PCT/CN2022/112096, filed on Aug. 12, 2022, the international application of which was published on May 11, 2023, as International Publication No. WO2023077904A1, and claims the priority of China Patent Application No. CN202111307026.7, filed on Nov. 5, 2021 in People's Republic of China. The entirety of each of the above patent applications is hereby incorporated by reference and made a part of this specification.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to the field of optical communication technology, and more particularly to an optical module.

### BACKGROUND OF THE DISCLOSURE

An optical module that is a core device for optical to electric and electric to optical conversion in an optical communication system, and usually includes a housing, and a circuit board assembly, an optical transmitter assembly, and/or an optical receiver assembly that are disposed in the housing. The housing has an electrical interface and an optical interface provided therein, one end of the circuit board within the housing being an electrical connection end. The electrical connection end is electrically connected to an electrical interface within an optical cage of an optical communication host via the electrical interface, and the optical interface is used to connect to an external optical fiber. Through external optical fiber, an optical transmission with the optical module within a remote optical communication host is achieved.

As disclosed in the background technology of the China Patent Application “Optical Module” with the application number of 201410851476.6 and published on Apr. 8, 2015, each of an optical transmitting assembly and an optical receiving assembly within the commonly used optical module are generally packaged as an optical transmitting sub-module and an optical receiving sub-module, which are then electrically connected to the rigid circuit board via a flexible circuit board, respectively, so as to realize signal transmission between the rigid circuit board and the photoelectric chips in the optical transmitting sub-module and optical receiving sub-module. Alternatively, as disclosed in embodiments thereof, both the optical transmitting assembly and the optical receiving assembly are assembled within the same sub-module, and the sub-module is then electrically connected to the rigid circuit board via the flexible circuit board.

An optical module provided in China Patent Application “Optical Module” with the application Ser. No. 20/171,0590788.X, published on Jul. 19, 2017, includes a housing, a heat sink device disposed within the housing and thermally connected to the housing, a printed circuit board partially disposed on the heat sink device, and laser chips and detector chips disposed on the heat sink device. The laser chips and the detector chips are both electrically connected to the circuit board. In order to absorb processing errors and assembly errors of the heat sink device and the circuit board, etc., an optical interface structure at one end of the housing needs to be disposed as a discrete structure, i.e., a movable head, with respect to the housing, so as to improve the assembly tolerance by adjusting the optical interface structure (i.e., the movable head) during the assembly process.

However, regardless of the packaging method, the laser chips and the detector chips as well as the wavelength division multiplexer/demultiplexer, the lens, and other optical processing elements are first assembled on a carrier, and then connected to a circuit board, and then finally assembled into the housing of the optical module. The above packaging methods have the following shortcomings: 1., more structural components, complex production process, and long production process; 2., the heat dissipation path of device being longer and parts need to use low thermal conductivity materials, thus affecting enhancement of the performance of the module in the full temperature range; 3., the module having a relatively high ratio of invalid space therein that is not conducive for the module to be developed in a direction of miniaturization and high-density integration; 4., variations in structure, the module assembly process and production having higher costs, posing obstacles for application of the module in batch, and so on. The above problems on the one hand, affect the heat dissipation performance and integration of optical modules, and on the other hand, the cost of optical modules remains high, making it difficult to reduce costs.

### SUMMARY OF THE DISCLOSURE

The purpose of the present disclosure is to provide an optical module that facilitates assembly and reprocessing, so as to effectively reduce product cost.

In order to achieve one of the above-mentioned goals, the present application provides an optical module that includes a housing, a circuit board assembly, an optical assembly, and an optical receptacle; the housing includes a first housing, a second housing, and an optical fiber adapter, and the first housing is covered with the second housing to form an internal accommodating cavity; the circuit board assembly and the optical assembly are disposed in the internal accommodating cavity; the circuit board assembly includes a rigid circuit board;

the housing has an electrical interface and an optical interface, and the circuit board assembly is fixed on the first housing and adjacent to one end with the electrical interface;

the optical assembly is fixed to the first housing, the optical assembly includes an optical processing assembly and photoelectric chips, and the optical processing assembly includes a wavelength division multiplexer, a lens group located between the wavelength division multiplexer and the photoelectric chips, and a lens group between the wavelength division multiplexer and the optical receptacle, respectively; the optical processing assembly is used for optical transmission between the photoelectric chips and the optical receptacle, and the photoelectric chips are adjacent to the rigid circuit board and electrically connected to the rigid circuit board;

the optical fiber adapter is disposed at the optical interface of the housing, the optical fiber adapter is integrally molded with the optical interface, and one end of the optical receptacle extends into the optical fiber adapter; the optical fiber adapter, the optical receptacle, the optical assembly, and the rigid circuit board have hard connections therebetween.

As a further improvement on the embodiments, the optical fiber adapter is partially integrally molded with the first housing and partially integrally molded with the second housing, and the first housing and the second housing are matched together to form the optical fiber adapter at the optical interface; or, the optical fiber adapter is integrally molded with the first housing.

As a further improvement on the embodiments, the circuit board assembly is fixed within the first housing by glue, fasteners, and/or snaps.

As a further improvement on the embodiments, the photoelectric chips include laser chips;

the laser chips are disposed on a substrate, and the laser chips are electrically connected to the substrate;

the substrate is electrically connected to the rigid circuit board by bonding wires or transfer boards, or, the rigid circuit board is electrically connected to the substrate by lap-jointing.

As a further improvement on the embodiments, the optical module further includes transimpedance amplifiers, the photoelectric chips include photodetector chips, the photodetector chips are electrically connected to the transimpedance amplifiers via bonding wires, and the transimpedance amplifiers are electrically connected to the rigid circuit board via bonding wires.

As a further improvement on the embodiments, the first housing includes a bottom plate, and the optical processing assembly is directly fixed to the bottom plate through an adhesive layer.

As a further improvement on the embodiments, the optical assembly further includes an optical device carrier, and the optical processing assembly and the photoelectric chips are disposed on the optical device carrier; the optical device carrier is fixed in the first housing.

As a further improvement on the embodiments, the optical device carrier has a first carrying surface, the lens group between the wavelength division multiplexer and the optical receptacle is a third lens group, and the third lens group is fixed to the first carrying surface.

As a further improvement on the embodiments, the lens group between the wavelength division multiplexer and the optical receptacle is a third lens group; the optical receptacle includes a sleeve assembly and an optical fiber ferrule, the optical fiber ferrule is disposed at one end of the sleeve assembly adjacent to the optical processing assembly, and another end of the sleeve assembly away from the optical processing assembly is used to receive an optical fiber ferrule of an external optical fiber when connecting to an external optical fiber;

the one end of the sleeve assembly adjacent to the optical processing assembly has an extension structure, and the third lens group is mounted on the extension structure.

As a further improvement on the embodiments, the optical receptacle is fixed in the first housing.

As a further improvement on the embodiments, the optical processing assembly includes a transmitting-end optical processing assembly and a receiving-end optical processing assembly, and the transmitting-end optical processing assembly includes the wavelength division multiplexer and a first periscope; the receiving-end optical processing assembly includes a wavelength division demultiplexer and a second periscope.

As a further improvement on the embodiments, the optical receptacle includes a transmitting-end optical receptacle and a receiving-end optical; receptacle; the photoelectric chips include laser chips and photodetector chips

the laser chips, the wavelength division multiplexer, and the receiving-end optical receptacle are located on a same side within the first housing, and the photodetector chips, the wavelength division demultiplexer, and the transmitting-end optical receptacle are located on another side within the first housing;

the first periscope and the second periscope overlap with each other, the first periscope guides optical signals that are output from the wavelength division multiplexer to the side with the transmitting-end optical receptacle, and the second periscope guides optical signals that are received by the receiving-end optical receptacle into the wavelength division demultiplexer.

Advantageous effects of the present application are: components within the optical module are all in hard connections, and an absorption of tolerances by soft connections of an FPC, an optical fiber, or a movable head is not required, such that a quantity of material is reduced and an assembly process is simplified, therefore the assembly is simpler and more convenient and effectively reduces the cost.

### BRIEF DESCRIPTION OF THE DRAWINGS

FIG. 1 is a schematic view of a common optical module and an optical cage of an optical communication host;

FIG. 2 is a schematic structural view of an optical module according to a first embodiment of the present disclosure;

FIG. 3 is a schematic exploded view of the optical module of FIG. 2;

FIG. 4 is a schematic structural view of an optical receptacle;

FIG. 5 is another schematic structural view of the optical receptacle;

FIG. 6 is a schematic structural view of the optical module according to a second embodiment of the present disclosure; and

FIG. 7 is a schematic structural view of the optical module according to a third embodiment of the present disclosure.

### DETAILED DESCRIPTION OF THE EXEMPLARY EMBODIMENTS

The present application will be described in detail below with reference to the specific embodiments shown in the accompanying drawings. However, these embodiments do not limit the present application, and any structural, methodical, or functional changes made by those of ordinary skill in the art based on these embodiments are included in the protection scope of the present application.

In the various drawings of the present application, certain dimensions of structures or portions may be exaggerated with respect to other structures or portions for ease of illustration and, therefore, are only used to illustrate the basic structures of the subject matter of the present application.

In addition, terms used herein such as “on”, “above”, “under”, “below” and other terms indicating relative positions in space are used for convenience of explanation to describe the relationship of one member or feature relative to another member or feature as shown in the drawings. The terms indicating relative positions in space may be intended to encompass different orientations of the device in use or operation in addition to the orientation depicted in the figures. For example, if the device in the diagram is turned over, elements described as “under” or “below” other elements or features are then oriented “above” the other elements or features. Thus, the exemplary term “below” may encompass both upper and lower orientations. The device may be otherwise oriented (to rotate by 90 degrees or other orientations) and the spatially relative descriptors used herein can be interpreted accordingly. When an element or layer is referred to as being “on” or “connected to” another component or layer, it can be directly on another component or layer or connected to another component or layer, or an intermediate element or layer may be present.

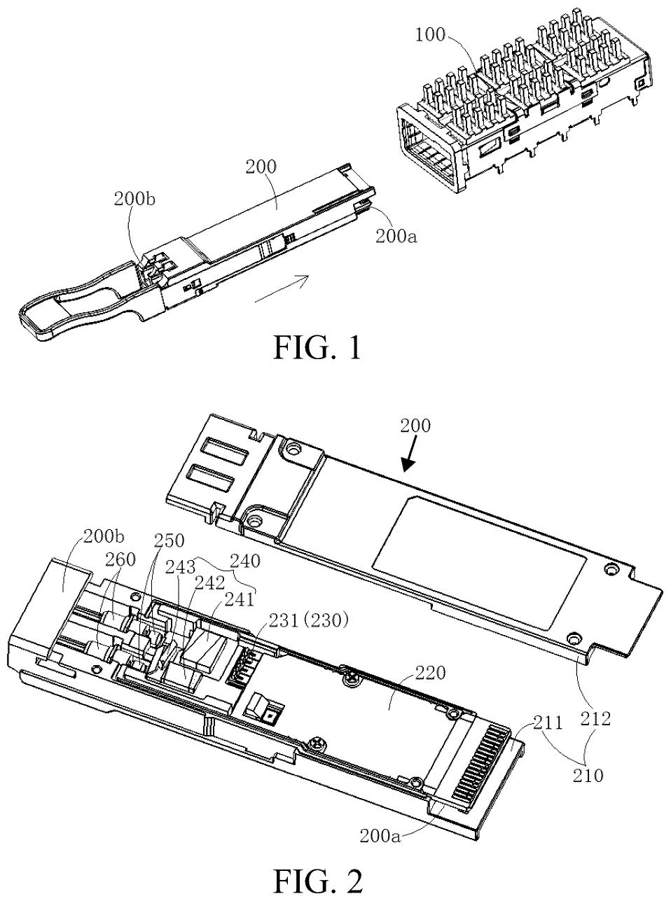

As shown in FIG. 1, an optical module 200 is usually mounted in an optical cage 100 of the optical communication host in a pluggable manner. The optical module 200 generally includes a housing, and a circuit board assembly, an optical emitting assembly and/or an optical receiving assembly that are disposed in the housing. The housing is provided with an electrical interface 200a and an optical interface 200b, and one end of the circuit board assembly within it is an electrical connection end, the electrical connection end (typically a gold finger) is electrically connected to an electrical interface in the optical cage 100 of the optical communication host through the electrical interface 200a, and the optical interface 200b is an optical fiber adapter, used to connect to an external optical fiber, and realize optical transmission with an optical module of the remote optical communication host through the external optical fiber.

### EMBODIMENT 1

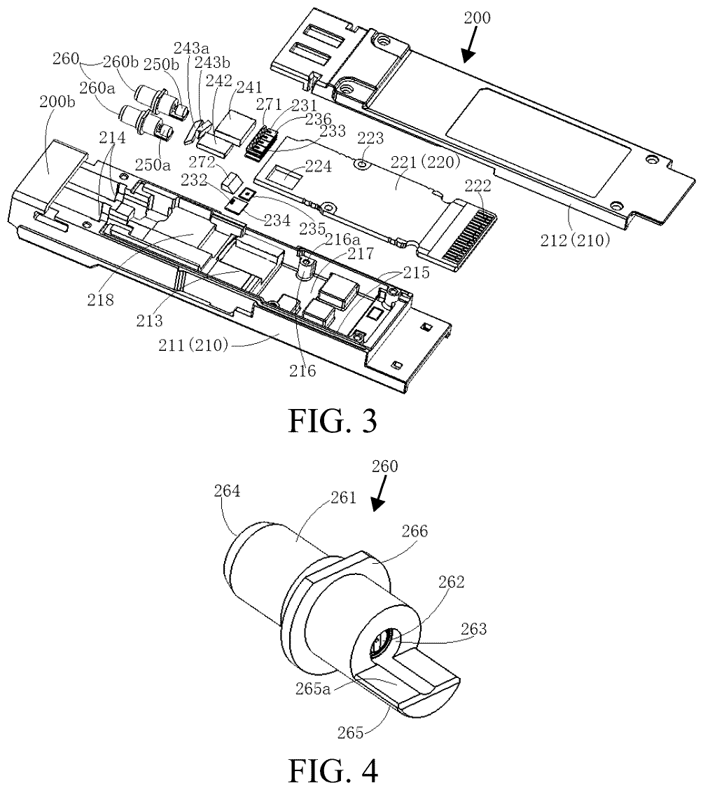

As shown in FIGS. 2 and 3, the optical module of this embodiment includes a housing 210, a circuit board assembly 220, and an optical assembly; the optical assembly includes photoelectric chips 230 and an optical processing assembly 240. In which, the housing 210 includes a first housing 211 and a second housing 212. The first housing 211 is covered with the second housing 212 to form an internal accommodating cavity. The housing 210 is provided with an optical interface 200b and an electrical interface 200a; the above-mentioned circuit board assembly 220, the photoelectric chips 230, and the optical processing assembly 240 are located in the internal accommodating cavity of the housing 210.

In this embodiment, the circuit board assembly 220 includes a rigid circuit board 221 (referred to as a circuit board), electronic elements (not shown in the figures), and electrical chips; the electrical chips are such as controllers, signal processors, drivers, and transimpedance amplifiers, in which the driver and the transimpedance amplifier can be located on the rigid circuit board 221, or can be not located on the rigid circuit board 221 but be provided on a bottom plate 213 of the first housing 211 together with the photoelectric chips. The rigid circuit board 221 is fixed on the above-mentioned first housing 211. One end (the electrical connection end 222) of the rigid circuit board 221 extends out of the above-mentioned electrical interface 200a for electrically connecting to the electrical interface in the optical cage of the optical communication host. The rigid circuit board 221 can be fixed to the first housing 211 by locking with fasteners such as screws, or by snapping or gluing, or can be fixed on the first housing 211 by locking with screws or snapping combined with gluing. In this embodiment, the rigid circuit board 221 is locked and fixed on the first housing 211 through screws. Specifically, the bottom plate 213 of the first housing 211 is provided with a platform 216 for supporting the above-mentioned rigid circuit board 221; the platform 216 is provided with a threaded hole 216a, and the rigid circuit board 221 has a through hole 223 provided at the position corresponding to the threaded hole 216a. A screw passes through the through hole 223 and is locked into the threaded hole 216a, and the screw nut presses the rigid circuit board 221, thereby fixing the rigid circuit board 221 on the platform 216. In this embodiment, the platforms 216 are respectively located at inner sides of two side walls 215 of the first housing 211 for supporting two edges of the rigid circuit board 221. In other embodiments, the platforms can also be disposed in a middle area of the bottom plate of the first housing for supporting the middle position of the rigid circuit board.

The above-mentioned first housing 211 includes the bottom plate 213 and the side walls 215 respectively located on two lateral sides of the bottom plate 213; the photoelectric chips 230 are disposed on the bottom plate 213, and the photoelectric chips 230 are electrically connected to the rigid circuit board 221; the optical processing assembly 240 is located a position on the bottom plate 213 adjacent to the optical interface 200b, and the optical processing assembly 240 is used for optical transmission between the photoelectric chips 230 and the optical interface 200b.

In this embodiment, the optical module 200 is a transceiver integrated optical module, the photoelectric chips 230 include laser chips 231 and photodetector chips 232, and the optical processing assembly 240 includes a transmitting-end optical processing assembly and a receiving-end optical processing assembly. The laser chips 231 are fixed on the bottom plate 213 of the first housing 211 through a substrate 236, and the substrate 236 is fixed to the bottom plate 213 by adhesion or soldering; the laser chips 231 are electrically connected to the substrate 236, and the substrate 236 is electrically connected to the above-mentioned rigid circuit board 221. Generally, the laser chips 231 are mounted on the substrate 236 through a eutectic welding process to form a chip on carrier (COC) structure. The laser chips 231 can be electrically connected to the substrate 236 through wire bonding and the above-mentioned eutectic welding, and the substrate 236 is then electrically connected to the rigid circuit board 221 through bonding wires or a transfer board, so as to realize the electrical connection from the rigid circuit board 221 to the laser chips 231. In this embodiment, the substrate 236 is disposed on a thermoelectric cooler (TEC) 233, and the temperature of the COC is controlled through the TEC 233; another side of the TEC 233 is fixed on the bottom plate 213 and dissipates heat directly through the bottom plate 213. In other embodiments, the substrate can also be directly bonded to the bottom plate through an adhesive, and the substrate itself has an electrical isolation function to electrically isolate a conductive layer of the substrate and the laser chips from the first housing. Alternatively, an electrical isolation layer, such as an aluminum nitride sheet, can be provided between the substrate and the bottom plate of the first housing to achieve electrical isolation between the laser chips and the first housing.

In order to shorten a signal transmission distance between the laser chips 231 and the rigid circuit board 221, the substrate 236 is generally located on a position outside the rigid circuit board 221 and adjacent to the edge of the rigid circuit board 221. In this embodiment, a driver is provided on the rigid circuit board 221, and in other embodiments, the driver can also be provided on the substrate. Herein, the position outside the rigid circuit board 221 and adjacent to the edge of the rigid circuit board 221 includes an outer side of an end surface of an end portion of the rigid circuit board 221 and one side of a side wall of an avoidance through hole formed on the rigid circuit board 221; that is, the position is not on the board of a rigid circuit board.

In this embodiment, the rigid circuit board 221 has an avoidance hole 224, and the photodetector chips 232 and the transimpedance amplifier 235 are located in the avoidance hole 224 and fixed to a position on the bottom plate 213 of the first housing 211 corresponding to the avoidance hole 224. An electrical isolation layer 234, such as an aluminum nitride sheet, etc. is disposed at a position corresponding to the avoidance hole 224 on the bottom plate 213. The photodetector chips 232 and the transimpedance amplifier 235 are bonded to the electrical isolation layer 234, the photodetector chips 232 are electrically connected to the transimpedance amplifier 235 through bonding wires, and the transimpedance amplifier 235 is electrically connected to the rigid circuit board 221 through bonding wires, thereby realizing the electrical connection from the photodetector chips 232 to the rigid circuit board 221. The avoidance hole 224 may be a square through hole in the rigid circuit board 221, or a U-shaped through hole at the end portions or lateral sides of the rigid circuit board 211. In other embodiments, the photodetector chips and the transimpedance amplifier can also be disposed on a position outside the rigid circuit board and adjacent to the edge of the rigid circuit board, or the transimpedance amplifier can also be disposed on the rigid circuit board.

In optical communications, an optical module has a main heat dissipation housing and a secondary heat dissipation housing (a top surface and a bottom surface specified in the multi-source agreement). In this embodiment, the first housing 211 is the main heat dissipation housing of the optical module, and the second housing 212 is the secondary heat dissipation housing. When the optical module is inserted into the optical cage of the optical communication host, the first housing 211 is adjacent to a heat dissipation mechanism of the optical cage that is the main area for heat dissipation between the optical module and the external environment. The photoelectric chips 230, such as the laser chips 231 and their substrates 236 (COC structures), the photodetector chips 232, etc. and main power consumption chips such as a transimpedance amplifier and a driver, etc. are arranged on the bottom plate of the first housing 211, and the heat generated during operation can be quickly dissipated directly from the first housing 211, so as to have a more rapid heat dissipation path and faster heat dissipation speed than through the heat sink and heat dissipation paste to the first housing in the conventional technology, thereby effectively improving the heat dissipation performance of the optical module.

The optical module in this embodiment is a multi-channel optical transceiver module. The optical interface 200b of the housing 210 is provided with a transmitting-end optical receptacle 260a and a receiving-end optical receptacle 260b. The transmitting-end optical processing assembly includes a wavelength division multiplexer 241, and a first collimating lens array (i.e., the first lens group) 271 is provided between the wavelength division multiplexer 241 and the laser chips 231. A first coupling lens group 250a is provided between the wavelength division multiplexer 241 and the transmitting-end optical receptacle 260a. Multiple beams of light emitted by the multiple laser chips 231 are respectively collimated by the respective collimating lens of the first collimating lens array 271, and then incident to the wavelength division multiplexer 241, and are combined into a beam of combined light by the wavelength division multiplexer 241; the beam of combined light is coupled into the transmitting-end optical receptacle 260a through the first coupling lens group 250a, and is transmitted to an external optical fiber through the transmitting-end optical receptacle 260a. The receiving-end optical processing assembly includes a wavelength division demultiplexer 242; a second coupling lens array (i.e., a second lens group) 272 is provided between the wavelength division demultiplexer 242 and the photodetector chips 232, and a second collimating lens group 250b is provided between the wavelength division demultiplexer 242 and the receiving-end optical receptacle 260b; the above-mentioned first coupling lens group 250a and the second collimating lens group 250b constitute a third lens group 250 that is correspondingly located at the ports of the transmitting-end optical receptacle 260a and the receiving-end optical receptacle 260b. After receiving a composite optical signal transmitted by the external optical fiber, the receiving-end optical receptacle 26b transmits the received composite optical signal to the second collimating lens group 250b; the composite optical signal is collimated by the second collimating lens group 250b and then incidents to the wavelength division demultiplexer 242, and is demultiplexed into multiple single-channel optical signals by the wavelength division demultiplexer 242; each of the single-channel optical signals is coupled to the corresponding photodetector chip 232 through the respective coupling lenses of the second coupling lens array 272; each photodetector chip 232 respectively converts the respective single-channel optical signal into an electrical signal to be transmitted to the transimpedance amplifier 235, and the transimpedance amplifier 235 amplifies each electrical signal that is then transmitted to the rigid circuit board 221 for being signal processed on the rigid circuit board 221 and being uploaded to the optical communication host through the electrical interface 200a. In other embodiments, the wavelength division multiplexer and the wavelength division demultiplexer can also be replaced by a photonic integrated chip (PIC) or other optical waveguide chips; the photonic integrated chip or the optical waveguide chip is bonded to the bottom plate of the first housing of the optical module by soldering or a thermally conductive adhesive.

In this embodiment, taking a dual-port optical module as an example, that is, providing one transmitting port and one receiving port, the above-mentioned first coupling lens group 250a is a coupling lens, and the second collimating lens group 250b is a collimating lens. In an optical module with more than two ports, such as with two transmitting ports and two receiving ports, the above-mentioned first coupling lens group includes two coupling lenses corresponding to the two transmitting ports, respectively, and the second collimating lens group includes two collimating lenses corresponding to the two receiving ports, respectively. Naturally, in other embodiments, the optical module can also be a bi-directional transmission optical module that transmits and receives via a single port; at this time, the third lens group is a single lens, which is simultaneously used to couple the emitted optical signal to the optical receptacle and to collimate the optical signal received by the optical module to the optical processing assembly at the receiving-end.

In this embodiment, the optical processing assembly also includes optical path deflecting prisms (periscopes) 260, and the transmitting-end optical processing assembly is provided with a first periscope 243a disposed between the wavelength division multiplexer 241 and the first coupling lens group 250a for being used to adjust the optical path between the wavelength division multiplexer 241 and the first coupling lens group 250a and the transmitting-end optical receptacle 260a. The receiving-end optical processing assembly is provided with a second periscope 243b disposed between the second collimating lens group 250b and the wavelength division demultiplexer 242 for being used to adjust the optical path between the receiving-end optical receptacle 260b, the second collimating lens group 250b and the wavelength division demultiplexer 242. In order to have a more reasonable layout for the design of the high-speed signal path of the transmitting-end optical assembly and the receiving-end optical assembly to the circuit board assembly in the optical module, respectively, while meeting the requirements of the multi-source agreement (MSA), in this embodiment, the transmitting-end optical assembly such as the laser chips and the wavelength division multiplexer, etc. and the receiving-end optical receptacle in the housing of the optical module are located on a same side of the first housing (that is, a left or right side when facing the optical interface), and the receiving-end optical assembly such as the photodetector chips and the wavelength division demultiplexer, etc. and the transmitting-end optical receptacle are located on another side of the first housing. The first periscope 243a and the second periscope 243b overlap with each other, the first periscope 243a guides optical signals that are output from the wavelength division multiplexer to the side with the transmitting-end optical receptacle 260a that is a different side from the wavelength division multiplexer, and the second periscope 243b guides optical signals that are received by the receiving-end optical receptacle 260b into the wavelength division demultiplexer that is located on the side that is a different side from the receiving-end optical receptacle 260b. In this way, by designing an inclination angle of periscopes 243 relative to the bottom plate 213 of the first housing 211 as required, the optical path can be guided to a corresponding height, such that the layout design in the housing of the optical module becomes more flexible. Moreover, this design can lengthen a length of the periscope to facilitate the manufacture of the periscope and the coupling of the optical path.

In this embodiment, the optical processing assembly is bonded to the bottom plate 213 of the first housing 211 through an adhesive layer. At the transmitting-end, the first collimating lens array 271 is disposed on the TEC 233 or an electrical isolation layer, and the wavelength division multiplexer 241 and the first periscope 243a at the transmitting-end are directly bonded to the bottom plate 213 through an adhesive layer (not shown in the figures); the thickness of the adhesive layer is adjusted according to the optical path, such that the wavelength division multiplexer 241 and the first periscope 243a are aligned with each other and are aligned with front and rear optical paths, respectively. At the receiving-end, the photodetector chips 232 adopt surface receiving chips, reflector are provided above the photodetector chips 232, and the second coupling lens array 272 is located above the photodetector chips 232 together with the reflector to reflect and couple each of the optical signals output by the wavelength division demultiplexer 242 to the respective photodetector chips 232, respectively. In other embodiments, the second coupling lens array can also be replaced by a large lens. The wavelength division demultiplexer 242 and the second periscope 243b at the receiving-end are also directly bonded to the bottom plate 213 through the adhesive layer. The thickness of the adhesive layer is adjusted according to the optical path, such that the wavelength division demultiplexer 243 and the second periscope 243b are aligned with each other and are aligned with the front and rear optical paths, respectively.

The optical module directly uses the housing of the optical module as a carrier to carry the optical processing assembly and main power consumption chips, thereby omitting a heat sink carrying the photoelectric chips and a carrier carrying the optical processing assembly, so as to reduce the structural parts in the optical module, and the assembly process is optimized, which lowers the costs, and reduces the occupation of redundant space, so as to improve the utilization of effective space in the optical module to have a higher degree of integration.

In this embodiment, the bottom plate 213 of the first housing 211 includes a first mounting area 217 and a second mounting area 218, the above-mentioned rigid circuit board 221 is fixed to the first mounting area 217, and the laser chips 231 and the optical processing assembly are fixed to the second mounting area 218. The first housing 211 has a first reference, and the optical processing assembly is fixed on the second mounting area 218 at a first preset position based on the first reference. Herein, the first reference may be a mark provided in the second mounting area 218, a junction between the ports and side walls of the first housing 211, or a limiting structure in the first housing 211, etc. In this embodiment, the second mounting area 218 is provided with a periscope positioning groove, a wavelength division multiplexer limiting groove, and a wavelength division demultiplexer limiting groove, etc., according to a design of the optical path. In other embodiments, the second mounting area may also be a plane, and optical elements such as periscopes, wavelength division multiplexers, and wavelength division demultiplexers, etc. are mounted on the plane; by adjusting the thickness of the adhesive layer between each of the optical elements and the plane, the optical elements can be aligned. Alternatively, the second mounting area includes multiple mounting platforms of different heights, which are respectively used to mount periscopes, wavelength division multiplexers, wavelength division demultiplexers, and photoelectric chips, etc.; one end of the rigid circuit board adjacent to the photoelectric chips can be bonded and fixed to a mounting platform carrying the photoelectric chips on the first mounting area of the bottom plate. This structure has lower requirements on the processing precision of the first mounting area and the second mounting area, and can effectively reduce the processing cost of the housing.

During assembly, the optical receptacle 260, the optical processing assembly 240, the photoelectric chips 230, and the circuit board assembly 220 are each mounted into the first housing 211 based on the first housing 211 of the optical module. The photoelectric chips 230 and the rigid circuit board 221 are electrically connected by wire bonding (such as gold wires) or transfer boards between the photoelectric chips 230 and the rigid circuit board 221. By adjusting the third lens group 250, the optical signal can be coupled between the optical processing assembly 240 and the optical receptacle 260; the first collimating lens array (first lens group) 271 is adjusted such that the optical signals emitted by the laser chips 231 are collimated and then incidents to the optical processing assembly 240, and the second coupling lens array (second lens group) 272 is adjusted to couple each optical signal output by the optical processing assembly 240 to the respective photodetector chip 232, respectively. Each of the assemblies is mounted based on the housing of the optical module; by adjusting the third lens group, the assembly tolerances between the aforementioned optical processing assembly, the photoelectric chips, and the circuit board can be absorbed; therefore, there is no need to further adjust the optical interface of the housing, and the optical interface of the housing can be integrally formed with the first housing, so as to achieve full hard connections between all assemblies in the optical module. That is, in the housing, those between the rigid circuit board, the photoelectric chips, the optical processing assembly and the optical receptacle are all in hard connection; there is no need for flexible circuit boards or optical fibers to absorb assembly tolerances, and there is no need to configure the optical interface as a movable head, thereby further simplifying the structure of the optical module. Moreover, the optical receptacle, the optical processing assembly, the laser chips, the photodetector chips, and the circuit board assembly, etc. are all mounted and placed in the first housing based on the optical module housing (the first housing), which simplifies the production and assembly process, and can further improve production efficiency and reduce costs. At the same time, more space is freed up around each device, and more crucial elements can be disposed, thereby further optimizing the disposition within the module, improving integration, and facilitating the realization of miniaturized packaging of high-speed optical modules.

In common packaging manners, the optical receptacle and other optical elements in the housing, specifically lenses adjacent to the optical receptacle, are mounted on the heat sink or the housing, respectively. During transportation or operation, when a position of one of the optical receptacle or the lenses is shifted relative to the housing or the heat sink, light loss may easily occur due to optical path mismatch, thus causing the optical module to fail and have lower reliability. On the other hand, in a common optical receptacle, the above-mentioned lenses may be integrated in a sleeve assembly of the optical receptacle; although the optical receptacle including the integrated lenses addresses the issue that the optical receptacle and the lenses are prone to mismatch, such structure is unable to adjust a relative positioning of the optical receptacle and the lenses. During the assembly of the optical module, for the optical receptacle including the integrated lenses, because the relative positioning of the lenses and the optical receptacle is fixed and is unable to be adjusted, the difficulty of optical path coupling is greatly increased. Therefore, in this embodiment, an improved optical receptacle structure is adopted to address the above-mentioned issue.

Specifically, as shown in FIG. 4, the optical receptacle 260 (the transmitting-end optical receptacle and the receiving-end optical receptacle) used in this embodiment includes a sleeve assembly 261 and an optical fiber ferrule 262. The optical fiber ferrule 262 is disposed within the sleeve assembly 261. In which, the sleeve assembly 261 is provided with a first end 263 and a second end 264 that are through; the first end 263 is used for coupling with the optical processing assembly in the optical module, and the second end 264 is used for connecting with the external optical fiber. The optical fiber ferrule 262 is disposed in a section of the sleeve assembly 261 adjacent to the first end 263, a section of the sleeve assembly 261 adjacent to the second end 264 is used to receive an optical fiber ferrule of the external optical fiber when connecting to the external optical fiber, and an end surface of the optical fiber ferrule 262 facing the second end 264 is used for mating with the ferrule of the external optical fiber connector. The first end 263 of the sleeve assembly 261 is provided with an extension structure 265 that extends axially along the optical receptacle 260; the extension structure 265 has a mounting surface 265a that is open, and the mounting surface 265a is used for mounting a lens (such as the above-mentioned third lens group), that is, the first coupling lens at the transmitting-end or the second collimating lens at the receiving-end, such that the lens is located in the optical path transmitted by the optical receptacle. In other embodiments, the mounting surface 265a can also be used for mounting other passive optical elements such as isolators or filters, etc. The third lens group can be fixed on the mounting surface 265a by soldering or adhesion. The mounting surface 265a that is open indicates that the mounting surface 265a has an opening in the radial direction of the sleeve assembly 261 to facilitate the adjustment and fixing of the lens during the coupling process. In this embodiment, the mounting surface 265a is a carrying plane located below a core extension line of the fiber ferrule 262 for carrying the above-mentioned lens. In other embodiments, the mounting surface can also be located at other positions on lateral sides of the core extension line of the optical fiber ferrule 262, and can be a flat surface or other shapes, such as being an L-shaped surface, a U-shaped surface, an arc surface, or a V-shaped surface, etc., that can facilitate the adjustment and fixing of the lens and is sufficient. That is, the mounting surface is located outside the core extension line of the optical fiber ferrule and faces the core extension line to make way for an optical transmission path, such that the light-permissive surfaces of the external optical element fixed on the mounting surface is aligned with the fiber core. In this embodiment, the extension structure and the sleeve assembly are an integrally formed structure, and the outer contour of the extension structure is an extension of the outer contour of the first end of the sleeve assembly. In other embodiments, the extension structure may also be soldered or bonded to be integral with the sleeve assembly.

By mounting the third lens group on the extension structure that is integral with the optical receptacle, the problem of light loss caused by displacement of the optical receptacle due to force displacement or aging creep is avoided, thereby effectively improving the reliability of the optical module. Moreover, during the assembly process, the optical path coupling between the optical receptacle and the optical processing assembly can be easily realized by adjusting the third lens group; after the adjustment is completed, the lens is fixed on the above-mentioned extension structure, which reduces the difficulty of optical path coupling. In this embodiment, the extension structure 265 and the sleeve assembly 261 are an integrally formed structure. In other embodiments, the extension structure may also be integral with the sleeve assembly by soldering or bonding.

As shown in FIG. 3, in this embodiment, the optical interface 200b of the optical module 200 is provided with an accommodating groove 214, and the above-mentioned optical receptacle 260 is disposed in the accommodating groove 214. The accommodating groove 214 is provided with a first limiting structure, and the optical receptacle 260 is provided with a second limiting structure 266. The first limiting structure and the second limiting structure 266 match to limit a position of the optical receptacle 260 in the accommodating groove 214. In this embodiment, the optical interface 200b is integrally formed with the first housing 211, and the optical receptacle 260 can be fixed in the above-mentioned accommodating groove 214 by adhesion or soldering, or can also be fixed in the above-mentioned accommodating groove 214 by other means such as snaps or screws. The above-mentioned first limiting structure may be a first protrusion or recess in the first housing 211, such as a protrusion or a flange, etc., and the second limiting structure 266 may be a second protrusion on the outer periphery of the sleeve assembly 261, such as protrusions or flanges, etc. During assembly, the second protrusion abuts against the first protrusion to limit the position of the optical receptacle 260 in a lengthwise direction of the optical module 200.

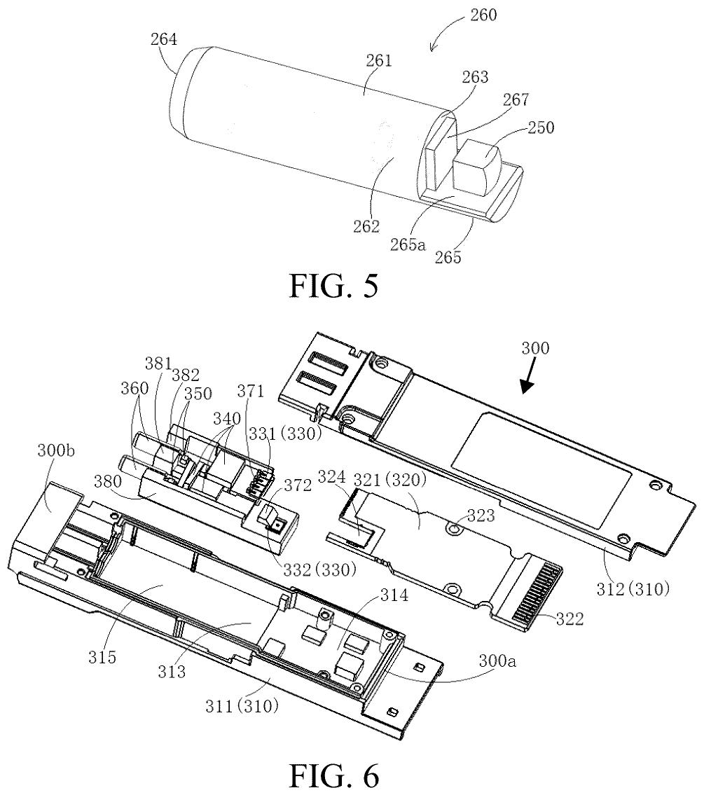

As shown in FIG. 5, another embodiment of an optical receptacle is provided; the above-mentioned optical module can also use an optical receptacle of this embodiment, and the assembly method of the optical receptacle in the optical module is the same as the optical receptacle of the above-mentioned embodiment. The optical receptacle 260 of this embodiment also includes the sleeve assembly 261 and the optical fiber ferrule 262. The optical fiber ferrule 262 is provided in the sleeve assembly 261. In which, the sleeve assembly 261 is provided with a first end 263 and a second end 264, the first end 263 is used for coupling with the optical processing assembly in the optical module, and the second end 264 is used for connecting with an external optical fiber. The optical fiber ferrule 262 is disposed on a position in the sleeve assembly 261 adjacent to the first end 263, and a section of the sleeve assembly 261 adjacent to the second end 264 is used to receive the optical fiber ferrule of the external optical fiber when connecting to the external optical fiber. The difference is that, in this embodiment, an optical window 267 is provided at the port of the sleeve assembly 261 on the first end 263 of the optical receptacle 260, so as to seal the optical fiber ferrule 262 in the sleeve assembly 261, thereby effectively sealing and protecting the end surface of the optical fiber ferrule 262. In other embodiments, an optical window can also be directly attached to the end surface of the optical fiber ferrule adjacent to the first end. In this embodiment, the optical window 267 is an optical flat sheet, such as a glass sheet, and an anti-reflective film can be provided on the light-permissive surfaces of the optical flat sheet to reduce surface reflection.

The sleeve assembly of the optical receptacle of this embodiment can be a sleeve assembly of a commonly used optical receptacle, that is, a sleeve assembly without an extension structure, or a sleeve assembly having an extension structure as in the above-mentioned embodiment, and the optical window is likewise provided on the port of the sleeve assembly adjacent to the third lens group.

### EMBODIMENT 2

As shown in FIG. 6, another optical module 300 is provided in the present application; the optical module 300 in this embodiment includes a housing 310, a circuit board assembly 320, and an optical assembly. The optical assembly includes an optical device carrier 380, photoelectric chips 330, and an optical processing assembly 340. In which, the housing 310 includes a first housing 311 and a second housing 312. The first housing 311 is covered with the second housing 312 to form an internal accommodating cavity; the optical module 300 is provided with an optical interface 300b and an electrical interface 300a; the above-mentioned circuit board assembly 320, the optical device carrier 380, the photoelectric chips 330, and the optical processing assembly 340 are located in the internal accommodating cavity of the housing 310.

In this embodiment, the optical device carrier 380 is a heat sink, which is generally a thermally conductive metal; the photoelectric chips 330 and the optical processing assembly 340 are disposed on the optical device carrier 380. In other embodiments, the optical device carrier may also include a first carrier and a second carrier that are joined together by lap-jointing-fixing or docking-fixing, in which the first carrier is a heat sink, and the second carrier is a carrier made of a material having a thermal expansion coefficient being close to or same as a thermal expansion coefficient of the optical processing assembly, that is, the thermal expansion coefficient of the second carrier matches with the thermal expansion coefficient of the optical processing assembly. The photoelectric chips are disposed on the first carrier, and the optical processing assembly is disposed on the second carrier plate, so as to avoid the problem of light loss when the ambient temperature has greater change due to a large difference in thermal expansion coefficients of the optical device carrier and the optical processing assembly. The optical device carrier 380 that carries the photoelectric chips 330 and the optical processing assembly 340 is fixed to the first housing 310 through a thermally conductive adhesive or soldering.

The above-mentioned circuit board assembly 320 includes a rigid circuit board 321, electronic elements, and electrical chips; the electrical chips are such as a controller, a signal processor, a driver, and a transimpedance amplifier, etc.; in which the driver and transimpedance amplifier can be disposed on the rigid circuit board 321, or can be not disposed on a rigid circuit board, but disposed on the optical device carrier together with the photoelectric chips. The rigid circuit board 321 is fixed on the above-mentioned first housing 311. One end (an electrical connection end 322) of the rigid circuit board 321 extends out of the above-mentioned electrical interface 300a for electrical connection with the electrical interface in the optical cage of the optical communication host. An end surface of one end of the rigid circuit board 321 adjacent to the photoelectric chips 330 abuts against the substrate of the photoelectric chips or the transimpedance amplifier, and is not fixed to the optical device carrier 380. Alternatively, the end surface of the one end of the rigid circuit board 321 adjacent to the photoelectric chips 330 abuts against an end surface of the optical device carrier 380 and does not overlap with the optical device carrier 380. The rigid circuit board 321 can be fixed on the first housing 311 by locking with fasteners such as screws, or by snapping or gluing, or can be locked or snapped to the first housing 311 through screws and other fasteners in conjunction with an adhesive. The optical device carrier 380 and the circuit board assembly 320 are respectively mounted and placed based on the first housing 311 and fixed in the first housing 311, respectively; the optical device carrier 380 and the rigid circuit board 321 do not need to be fixed to each other, which allows the assembly manner of the optical module to be more flexible, simplifies the production and assembly process, and facilitates detaching to promote reworking, which can further improve production efficiency and reduce costs. Specifically, the fixing manner of the rigid circuit board in this embodiment is the same as that in Embodiment 1. A through hole 323 is formed on the rigid circuit board 321, and screws pass through the through hole 323 and are threadedly locked into a threaded hole of the first housing 311, so as to lock the rigid circuit board 321 in the first housing 311.

Similar to Embodiment 1, the optical module of this embodiment is a transceiver integrated optical module. The photoelectric chips 330 include laser chips 331 and photodetector chips 332, the optical processing assembly 340 includes a transmitting-end optical processing assembly and a receiving-end optical processing assembly, and a transmitting-end optical path and a receiving-end optical path are the same as those in Embodiment 1. The assembly structure of the photoelectric chips 330 and the optical processing assembly 340 on the optical device carrier 380 is the same as that of the photoelectric chips and the optical processing assembly in Embodiment 1; the electrical connection manner between the photoelectric chips 330 and the circuit board assembly 320 is the same as in Embodiment 1, and will not be reiterated herein. The difference is that, in this embodiment, the optical processing assembly 340 is bonded to the optical device carrier 380 through an adhesive layer, and the optical device carrier 380 is fixed into the first housing 311 through bonding via a thermally conductive adhesive or soldering. Similarly, the above-mentioned rigid circuit board 321 has an avoidance hole 324, and the photodetector chips 332 and the transimpedance amplifier are disposed in the avoidance hole 324 and are fixed on a position on the optical device carrier 380 corresponding to the avoidance hole 324.

In this embodiment, the bottom plate 313 of the first housing 311 also includes a first mounting area 314 and a second mounting area 315; the above-mentioned rigid circuit board 321 is fixed to the first mounting area 314, and the optical device carrier 380 with the photoelectric chips 330 and the optical processing assembly 340 mounted thereon is fixed on the second mounting area 315. The first housing 311 is provided with a first reference, and the optical device carrier 380 with the photoelectric chips 330 and the optical processing assembly 340 mounted thereon is fixed on the second mounting area 315 at a first preset position that is based on the first reference. Herein, the first reference may be a mark provided in the second mounting area 315, a junction between the ports and side walls of the first housing, or a limiting structure in the first housing.

The optical device carrier 380 is provided with a second reference. Each optical element of the optical processing assembly 340 is bonded and fixed on the optical device carrier 380 at second, third or other preset positions that are based on the second reference through an adhesive layer. The second reference may be a mark or a limiting structure provided on the optical device carrier 380, or a corner of an end portion of the optical device carrier 380. In this embodiment, the optical device carrier 380 is provided with a periscope positioning slot, a wavelength division multiplexer limiting slot, and a wavelength division demultiplexer limiting slot, etc. according to a design of the optical path. In other embodiments, the optical device carrier can also be a plane, on which optical elements such as periscopes, wavelength division multiplexers, and wavelength division demultiplexers, etc. are mounted, and by adjusting the thickness of the adhesive layer between each optical element and the plane, the optical elements are aligned. Alternatively, the optical device carrier plate includes multiple mounting platforms of different heights, which are respectively used to mount periscopes, wavelength division multiplexers, wavelength division demultiplexers, and photoelectric chips, etc. This structure has lower precision requirements for the carrying surface of the optical device carrier 380 for carrying the optical processing assembly 340 and the photoelectric chips 330, which can effectively reduce the processing cost of the optical device carrier.

The optical module in this embodiment can adapt the same optical receptacle as in Embodiment 1. The optical receptacle can be fixed at the optical interface of the housing as in Embodiment 1, or can also be fixed on the optical device carrier. Taking the optical receptacle fixed on the optical device carrier as an example, the optical device carrier 380 is provided with a receptacle mounting part 381 at an end portion adjacent to the optical interface 300b, and the optical receptacle 360 is soldered, bonded, threadedly screwed, or snapped on the mounting part 381. The receptacle mounting part 381 may be a side wall provided at the end portion of the optical device carrier 380, and a receptacle accommodating groove 382 for mounting the optical receptacle 360 is provided on the side wall. The manner for mounting and positioning the optical receptacle 360 on the optical device carrier 380 can be the same as the manner for mounting and positioning the optical receptacle in the first housing in Embodiment 1, and will not be reiterated herein.

During assembly, the optical receptacle 360 and the optical processing assembly 340 are fixed on the optical device carrier 380 in a passive manner, and by adjusting a third lens group 350, optical signals are coupled between the optical processing assembly 340 and the optical receptacle 360. The photoelectric chips 330 are also passively fixed on the optical device carrier 380 or on a separate heat sink. The circuit board assembly 320 and the optical device carrier 380 carrying the photoelectric chips 330 and the optical processing assembly 340 are respectively mounted and fixed into the first housing 311 based on the first housing 311. The optical device carrier 380 and the rigid circuit board 321 do not need to be fixed to each other. Bonding wires (such as gold wires) are used between the photoelectric chips 330 and the rigid circuit board 321 to electrically connect the photoelectric chips 330 and the rigid circuit board 321, the first collimating lens array (a first lens group 371) is adjusted such that the optical signals emitted by the laser chips 331 are collimated and then incident to the wavelength division multiplexer, and the second coupling lens array (a second lens group 372) is adjusted to couple each optical signal output by the wavelength division multiplexer to the respective photodetector chip 332, respectively. The circuit board assembly 320 and the optical device carrier 380 are mounted based on the first housing 311 of the optical module 300. By adjusting the lens group, the assembly tolerance between the aforementioned optical processing assembly 340, the photoelectric chips 330, and the circuit board assembly 320 can be absorbed, therefore, there is no need to further adjust the optical interface of the housing, and the optical interface 300b of the housing 310 can be integrally formed with the first housing 311, so as to achieve full hard connection between all assemblies in the optical module. This structure does not require a flexible circuit board to absorb assembly tolerances, nor does it require the optical interface to be configured as a movable head, thereby further simplifying the structure of the optical module and simplifying the production and assembly process, which can further improve production efficiency and reduce costs.

### EMBODIMENT 3

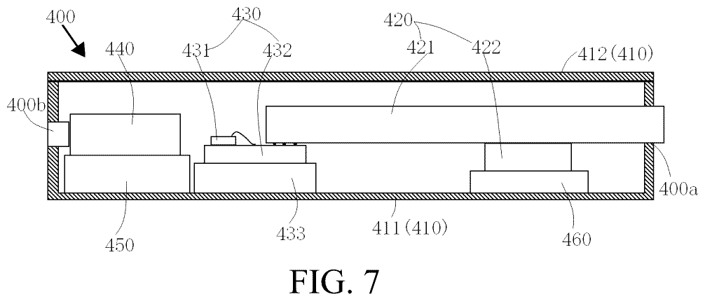

As shown in FIG. 7, another optical module 400 is provided in the present application. The optical module 400 in this embodiment includes a housing 410, a circuit board assembly 420, and an optical assembly. The optical assembly includes photoelectric chips 430 and an optical processing assembly 440. In which, the housing 410 includes a first housing 411 and a second housing 412; the first housing 411 is covered with the second housing 412 to form an internal accommodating cavity. The optical module 400 is provided with an optical interface 400b and an electrical interface 400a; the above-mentioned circuit board assembly 420, the photoelectric chips 430, and the optical processing assembly 440 are provided in the internal accommodating cavity of the housing 410.

In this embodiment, the photoelectric chips 430 include laser chips 431. The laser chips 431 are mounted on a substrate 432. The laser chips 431 are electrically connected to the substrate 432. A gold wire bonding process is usually used to realize the electrical connection between the laser chips 431 and the substrate 432. The circuit board assembly 420 includes a rigid circuit board 421 and electronic elements or integrated circuit chips disposed on the rigid circuit board 421, such as a digital signal processor (DSP) 422. In this embodiment, the substrate 432 is partially overlapped with the rigid circuit board 421, that is, the substrate 432 is lap-jointed with the rigid circuit board 421, and the surface of the substrate 432 of the lap-jointed portion is provided with an electrical connection end. The surface of the rigid circuit board 421 is also provided with an electrical connection end, and the above-mentioned electrical connection ends on the substrate 432 and the rigid circuit board 421 are electrically connected and fixed together by processes such as flip-chip soldering or anisotropic conductive film (ACF) to realize a direct hard connection from the circuit board assembly 420 to the photoelectric chips 430.

In this embodiment, the substrate 432 is thermally connected to the first housing 411 through a heat sink 433, the heat generated by the operation of the laser chips 431 is transferred to the first housing 411 through the substrate 432 and the heat sink 433, and then the heat is dissipated through the first housing 411. The optical processing assembly 440 is provided on an optical device carrier 450, and the optical processing assembly 440 may include a wavelength division multiplexer, a periscope, and a coupling lens, etc. The optical processing assembly 440 and the structure between it and the optical receptacle are similar to that of Embodiments 1 or 2, such that the hard connection between the photoelectric chips 430 and the optical interface 400b can be realized, thereby realizing the hard connection between all assemblies in the optical module; therefore, there is no need for a flexible circuit board to absorb assembly tolerances, and there is no need to configure the optical interface as a movable head, thereby further simplifying the structure of the optical module and simplifying steps of the production and assembly process, which can further improve production efficiency and reduce costs.

Since the electrical connection end of the rigid circuit board 421 is directly overlapped with the electrical connection end of the substrate 432 to achieve electrical connection, the above-mentioned electrical connection end of the circuit board 421, the DSP 422, and the high-speed signal transmission lines connecting the two can be disposed on the same surface of the rigid circuit board 421 that faces the above-mentioned substrate 432, such as both being disposed on a surface of the rigid circuit board 421 that faces the main heat dissipation housing (which is the first housing 411 herein); the DSP 422 is thermally connected to the first housing 411 through a heat dissipation pad 460, and the heat generated by it is directly transferred out through the first housing 411. The electrical connection ends of the laser chips 431 and the substrate 432 are on the same surface of the substrate 432, which is the side of the substrate 432 facing away from the first housing 411; the rear side of the substrate 432 faces the first housing 411, and is thermally connected to the first housing 411 through the heat sink 433. In this way, the high-speed signal transmission lines from the DSP 422 to the photoelectric chips 430 do not need to pass through electrically conductive vias, nor do they need gold wire bonding, and nor do they need a transfer board for connection, which reduces the impedance mutation of the high-speed signal transmission lines to effectively improve the high-frequency performance of assemblies and greatly increase the bandwidth of assemblies. At the same time, the heat generated by the operation of the main power consuming devices in the optical module: the laser chips 431 and the DSP 422, can be all directly transferred out from the first housing 411 (i.e., the main heat dissipation housing) of the housing 410, thereby further improving the heat dissipation performance of the optical module.

In other embodiments, a thermoelectric cooler (TEC) may be disposed between the above-mentioned substrate 432 and the heat sink 433 to further improve the heat dissipation efficiency of the laser chips 431. The above-mentioned heat sink 433 can also be an integral structure with the optical device carrier 450; or, the substrate 432 and the optical processing assembly 440 are directly bonded and fixed in the first housing 411, thereby eliminating the need for a heat sink or an optical device carrier.

In certain embodiments, referring to FIG. 3, the above-mentioned platform 216 is disposed on the first mounting area 217 of the bottom plate 213; the threaded hole 216a on the platform 216 and the corresponding through hole 223 on the rigid circuit board 221 can be regarded as two limiting structures on the platform 216 and the circuit board assembly 220, respectively; the position of the circuit board assembly 220 in the first housing 211 is limited by screw locking, thereby limiting the circuit board assembly 220 to be in the first mounting area 217. In other embodiments, the platform may be provided with protrusions as limiting structures that cooperate with limiting structures such as holes or notches on the rigid circuit board, thereby limiting the position of the circuit board assembly in the first housing. On the other hand, the limiting structures can be disposed on other positions in the first mounting area, so as to cooperate with the limiting structures on the circuit board assembly to limit a position of the circuit board assembly.

In other embodiments, the optical path deflecting prism (the periscope) can also be replaced by certain amounts of optical fibers; the optical fiber has improved flexibility that enables the design of the height and position of the optical processing assembly to be more flexible, not limited by the position of the optical receptacle, and only required to be aligned with the optical axis of the photoelectric chips, such that the design requirements for the bottom plate in the first housing or the optical device carrier are lower, and the assembly is simplified. Specifically, for example, an optical fiber section directly extends from one end of the optical receptacle adjacent to the optical processing assembly, and one end of the optical fiber section away from the optical receptacle is connected to an optical fiber fixing member; the above-mentioned third lens group is located between an optical fiber fixing member and the wavelength division multiplexer or the wavelength division demultiplexer, so as to perform optical coupling between the optical fiber section and the wavelength division multiplexer/wavelength division demultiplexer. On the other hand, the optical processing assembly includes certain amounts of optical fiber sections and coupling lenses; that is, the above-mentioned optical path deflecting prism and the wavelength division multiplexer/wavelength division demultiplexer are all replaced by the above-mentioned optical fiber sections, or replaced by an arrayed waveguide grating (AWG) wavelength division multiplexer, a planar light-wave circuit (PLC) wavelength division multiplexer with an optical fiber pigtail, or a photonic integrated chip. When being replaced by the above-mentioned optical fiber sections, a quantity of the optical receptacles is consistent with a quantity of optical channels (a total of a quantity of optical channels of the laser chips and a quantity of optical channels of the photodetector chips) of the photoelectric chips. Specifically, the above-mentioned optical fiber sections directly extend from one end of each of the optical receptacle adjacent to the photoelectric chips, one end of the optical fiber section away from the optical receptacle is connected to the optical fiber fixing member; a coupling lens is disposed between the optical fiber fixing member and the optical channel of each of the chips, so as to perform optical coupling between each of the optical fiber sections and the optical channel of the respective photoelectric chips.

The series of detailed descriptions listed above are only specific descriptions of feasible implementations of the present application, and they are not intended to limit the protection scope of the present application; any equivalent implementations or changes that do not deviate from the technical spirit of the present application should all be included in the protection scope of the present application.

What is claimed is:

1. An optical module, comprising a housing, a circuit board assembly, an optical assembly, and an optical receptacle; the housing includes a first housing, a second housing, and an optical fiber adapter, and the first housing is covered with the second housing to form an internal accommodating cavity; the circuit board assembly and the optical assembly are disposed in the internal accommodating cavity; the circuit board assembly includes a rigid circuit board; wherein,
the housing is provided with an electrical interface and an optical interface, and the circuit board assembly is fixed on the first housing and adjacent to one end with the electrical interface;
the optical assembly is fixed to the first housing, the optical assembly includes an optical processing assembly and photoelectric chips, and the optical processing assembly includes a wavelength division multiplexer, a lens group located between the wavelength division multiplexer and the photoelectric chips, and a lens group between the wavelength division multiplexer and the optical receptacle, respectively; the optical processing assembly is used for optical transmission between the photoelectric chips and the optical receptacle, and the photoelectric chips are adjacent to the rigid circuit board and electrically connected to the rigid circuit board;
the optical fiber adapter is disposed at the optical interface of the housing, the optical fiber adapter is integrally molded with the optical interface, and one end of the optical receptacle extends into the optical fiber adapter; wherein the optical fiber adapter, the optical receptacle, the optical assembly, and the rigid circuit board have hard connections therebetween.

2. The optical module according to claim 1,
wherein the optical fiber adapter is partially integrally molded with the first housing and partially integrally molded with the second housing, and the first housing and the second housing are matched together to form the optical fiber adapter at the optical interface; or, the optical fiber adapter is integrally molded with the first housing.

3. The optical module according to claim 1,
wherein the circuit board assembly is fixed within the first housing by glue, fasteners, and/or snaps.

4. The optical module according to claim 1, wherein,
the photoelectric chips include laser chips;
the laser chips are disposed on a substrate, and the laser chips are electrically connected to the substrate;
the substrate is electrically connected to the rigid circuit board by bonding wires or transfer boards, or, the rigid circuit board is electrically connected to the substrate by lap-jointing.

5. The optical module according to claim 1, wherein the optical module further comprising transimpedance amplifiers, and the photoelectric chips include photodetector chips, the photodetector chips are electrically connected to the transimpedance amplifiers via bonding wires, and the transimpedance amplifiers are electrically connected to the rigid circuit board via bonding wires.

6. The optical module according to claim 1,
wherein the first housing includes a bottom plate, and the optical processing assembly is directly fixed to the bottom plate through an adhesive layer.

7. The optical module according to claim 1,
wherein the optical assembly further includes an optical device carrier, and the optical processing assembly and the photoelectric chips are disposed on the optical device carrier; the optical device carrier is fixed in the first housing.

8. The optical module according to claim 7, wherein the optical device carrier has a first carrying surface, the lens group between the wavelength division multiplexer and the optical receptacle is a third lens group, and the third lens group is fixed to the first carrying surface.

9. The optical module according to claim 1, wherein,
the lens group between the wavelength division multiplexer and the optical receptacle is a third lens group; the optical receptacle includes a sleeve assembly and an optical fiber ferrule, the optical fiber ferrule is disposed at one end of the sleeve assembly adjacent to the optical processing assembly, and another end of the sleeve assembly away from the optical processing assembly is used to receive an optical fiber ferrule of an external optical fiber when connecting to an external optical fiber;
the one end of the sleeve assembly adjacent to the optical processing assembly has an extension structure, and the third lens group is mounted on the extension structure.

10. The optical module according to claim 1, wherein the optical receptacle is fixed in the first housing.

11. The optical module according to claim 1, wherein the optical processing assembly includes a transmitting-end optical processing assembly and a receiving-end optical processing assembly, and the transmitting-end optical processing assembly includes the wavelength division multiplexer and a first periscope; the receiving-end optical processing assembly includes a wavelength division demultiplexer and a second periscope.

12. The optical module according to claim 11, wherein,
the optical receptacle includes a transmitting-end optical receptacle and a receiving-end optical receptacle;
the photoelectric chips include laser chips and photodetector chips;
the laser chips, the wavelength division multiplexer and the receiving-end optical receptacle are located on a same side within the first housing, and the photodetector chips, the wavelength division demultiplexer and the transmitting-end optical receptacle are located on another side within the first housing;
the first periscope and the second periscope overlap with each other, the first periscope guides optical signals that are output from the wavelength division multiplexer to the side with the transmitting-end optical receptacle, and the second periscope guides optical signals that are received by the receiving-end optical receptacle into the wavelength division demultiplexer.
